(19) United States
(12) Patent Application Publication
(10) Pub. No.: US 2004/0143383 A1
(43) Pub. Date: Jul. 22, 2004

(54) Method for controlling and/or adjusting a torque transmission system in the drive chain of a vehicle

(75) Inventors: Klaus Kuepper, Buehl (DE); Thomas Jaeger, Buehl (DE); Michael Schindler, Buehl (DE); Claudio Castro, Sorocaba (BR)

Correspondence Address: DAVIDSON, DAVIDSON & KAPPEL, LLC, 485 SEVENTH AVENUE, 14TH FLOOR, NEW YORK, NY, 10018, US

(73) Assignee: Luk Lamellen und Kupplungsbau, Buehl (DE)

(21) Appl. No.: 10/714,754

(22) Filed: Nov. 17, 2003

Related U.S. Application Data
(63) Continuation of application No. PCT/DE02/01718, filed on May 14, 2002.

(30) Foreign Application Priority Data
May 17, 2001 (DE) DE 101 23 956.4

(51) Int. Cl. G06F 17/00

(52) U.S. Cl. 701/51; 701/67

(57) ABSTRACT

A method for controlling and/or adjusting a torque transmission system in the drive chain of a vehicle, especially a motor vehicle, wherein a clutch torque is modified according to a starting resistance of the vehicle in order to provide a strategy for the start of said vehicle. According to the invention, said strategy is modified in such a way that the progression of said clutch torque is adapted to a starting situation.

### CROSS-REFERENCE TO RELATED APPLICATIONS

The present application is a continuation of international application PCT/DE02/01718, filed May 14, 2002 and claiming priority to German Patent Application No. 101 23 956.4. Both international application PCT/DE02/01718 and German Patent Application No. 101 23 956.4 are hereby incorporated by reference herein.

### BACKGROUND INFORMATION

The present invention relates to a method for controlling and/or regulating a torque transmission system in a drivetrain of a vehicle, a motor vehicle in particular, in which a clutch torque is modified as a function of a starting resistance of the vehicle in order to implement a strategy for starting the vehicle.

Methods of this type for implementing a starting procedure in a vehicle are known from automotive engineering. For this purpose, the torque transmission system may, for example, change the clutch torque as a function of an existing starting resistance in such a way that the vehicle is started suitably.

In the known method, the starting resistance is determined in the strategy and in the event of a relatively large starting resistance the clutch torque is reduced accordingly. During hill starts in particular, it is possible in the known method that the engine of the vehicle is not outputting sufficient power in order to be able to start the vehicle on the hill, in particular in the event of larger grades.

Furthermore, it is possible in the known method that the clutch torque is changed too late, resulting in the vehicle rolling backward, in particular during hill starts, which is absolutely to be avoided.

The delay in influencing the clutch torque may arise in the known method because the driver requires a specific time to go from the brake pedal to the gas pedal to start and, in addition, a specific time is required in the method to bring the engine to a predetermined speed. The result is that the profile, i.e. the progression, of the clutch torque is disadvantageously not adapted to the driving situation in the known method due to these delays.

As a consequence, in the known method, a hill start may not be performed satisfactorily, in particular if the vehicle is fully loaded.

### BRIEF SUMMARY OF THE INVENTION

The present invention is therefore based on an object of providing a method in which a strategy for starting and/or for accelerating is performed, through which the above-mentioned disadvantages may be reduced or avoided.

The present invention provides a method for controlling and/or regulating a torque transmission system in a drivetrain of a vehicle, a motor vehicle in particular, in which a clutch torque is changed as a function of a starting resistance of the vehicle in order to implement a strategy for starting the vehicle, the strategy being modified in such a way that the progression, i.e. the profile or curve, of the clutch torque is adjusted to a starting situation.

Accordingly, in the method according to the present invention, the clutch torque is influenced by a suitable strategy for starting and/or for accelerating the vehicle in such a way that a particular starting or acceleration situation of the vehicle is taken into consideration. The method according to the present invention may also allow a vehicle having low power to drive up a relatively extreme grade, even if there are relatively high starting resistances for the vehicle.

A refinement of the present invention may provide that the progression of the clutch torque is defined by at least one operating parameter to be considered in the strategy. For example, this selected operating parameter may determine how rapidly the clutch torque is to be built up after a predetermined maximum and/or target engine speed has been achieved. Through suitable selection of the operating parameter, the type of progression of the clutch torque may thus be influenced in any way. The method according to the present invention may therefore optimally adapt the progression of the clutch torque to any starting situation.

For example, the clutch torque may be built up relatively slowly for hill starts. This has the advantage that the synchronization point of the engine speed and the transmission input speed is above a predetermined limit.

If the vehicle is to drive over a curb or the like, for example, the clutch torque may be built up relatively rapidly in the method according to the present invention. This is because a dynamic component of the engine torque is advantageously exploited in this way. Of course, the clutch torque may also be influenced in another suitable way in order to be adjusted to a starting situation of the vehicle.

It is particularly advantageous if, in the method according to the present invention, according to another refinement of the present invention, a starting situation of the vehicle is recognized. For example, it is recognized in this case whether the vehicle is located in front of a curb, a hill, or the like. This knowledge is then processed in the method in a suitable way, in particular in order to adapt the clutch torque to this starting situation and/or acceleration situation.

It is possible according to a refinement of the present invention, for example, that the starting situation of the vehicle is recognized via the vehicle velocity, for example. It is conceivable in this case that a curb is recognized if the velocity is zero or very small, for example. In contrast, a hill may be recognized if the velocity is not equal to zero.

It is particularly advantageous if a suitable sensor is used for recognizing a driving situation in the method according to the present invention. For example, it is possible in this case that the value of the vehicle velocity is calibrated as a function of the sensor, for example. Of course, in the method according to the present invention, other measures may also be used in order to recognize a driving situation.

In another embodiment of the present invention, the strategy may have a starting aid routine. In this case, the use of a multistage starting aid routine is particularly advantageous, since the activation of the torque transmission system may be adapted optimally to an existing starting resistance of the vehicle using this routine. It is conceivable for the starting aid routine to be integrated in an electronic clutch management (ECM) of the vehicle.

A two-stage starting aid routine may advantageously be provided. It is possible in this case that a higher maximum engine speed is implemented in the second stage of the starting aid routine than in the first stage, for example. Of course, still further stages may also be provided in the starting aid routine. In addition, other operating parameters may be varied in the routine.

By increasing the maximum engine speed, in the method according to the present invention, the engine torque may also be increased, so that more power may be provided in a predetermined driving situation, for example. In addition, the wear of the clutch may thus be reduced in the method according to the present invention. This is true in particular because, in the method according to the present invention, a grade, vehicle weight, and/or starting resistance recognition may be provided, for example, through which a higher maximum engine speed may be preset only in selected extreme driving situations, for example, such as in the event of high starting resistances. Therefore, in the method according to the present invention, there is no higher clutch wear in the event of normal starts and/or moderate starting resistances, since only the first stage of the starting aid routine is necessary.

The starting aid routine of the method according to the present invention, which is integrated into the electronic clutch management of the vehicle, for example, may recognize the starting resistance and, if it is too large, reduce the clutch torque appropriately, so that the engine may reach a speed range at which the engine may apply more torque.

In another embodiment of the present invention, roll direction recognition may be implemented in the starting aid routine. Preferably, at least one sensor is provided on the vehicle, using which the roll direction of the vehicle may be recognized. In this way, the starting aid routine is allowed to recognize the roll direction in any starting situation, so that the progression of the clutch torque may be adapted appropriately using the method according to the present invention.

According to an advantageous refinement of the present invention, in a predetermined time interval, the gradient of the transmission input speed and/or the gradient of the transmission speed is suitably observed and/or used in order to perform roll direction recognition. The time interval may be measured in accordance with when the clutch torque assumes a predetermined value, for example, in order to slow down the backward rolling of the vehicle in the event of a hill start after the throttle-valve angle has assumed a predetermined value.

In the event of a negative gradient of the transmission input speed, it may therefore be recognized that the vehicle is rolling backward and, in the event of a positive gradient, it may then be assumed that the vehicle is rolling forward.

A further embodiment of the method according to the present invention may provide that an engine speed regulation is provided in the method for the strategy of starting and/or accelerating the vehicle. A hill start of a vehicle may be made more difficult due to parameter variations of the system, for example. Such variations are possible through changes in the coefficient of friction of the torque transmission system and/or the clutch, for example. These variations may not be compensated for even through an adaptation in some circumstances.

For example, it is possible that the method recognizes a hill start after a specific time interval, e.g., after two seconds, and correspondingly reduces the clutch torque. The engine speed may be increased in such a way that the engine may output a larger engine torque. After a specific time, the clutch torque may then be increased again in a suitable way.

If the clutch torque is reduced by a predetermined factor, for example, a desired engine speed may not be achieved in the event of parameter variations of the system. Therefore, it is particularly advantageous in the method according to the present invention if the reduction of the clutch torque is ended even before a desired target engine speed is reached. Through the dynamic response of the engine and the overall system, the engine speed will rise immediately after the reduction of the clutch torque. When determining a target engine speed, care is to be taken that it is selected in such a way that the system is not damaged.

According to another refinement of the present invention, the limit and/or the target speed is determined through a constant component in combination with a component which is a function of the engine speed gradient. In this case, it is advisable if the constant component is implemented as a speed offset. Of course, the determination of the target speed may also be implemented in another way in the method according to the present invention in order to optimize it further.

The method according to the present invention may be provided in any type of torque transmission system and/or for activating clutches. The use in an electronic clutch management (ECM) and in an automatic transmission is particularly advantageous.

### BRIEF DESCRIPTION OF THE DRAWINGS

Further advantageous embodiments of the present invention result from the subclaims and from the attached figures.

FIG. 1 shows a flow chart of a first exemplary embodiment of a starting aid routine;

FIG. 2 shows a flow chart of a second exemplary embodiment of the starting aid routine;

FIG. 3 shows a flow chart of a third exemplary embodiment of the starting aid routine; and

FIG. 4 shows a flow chart of a fourth exemplary embodiment of the starting aid routine.

### DETAILED DESCRIPTION

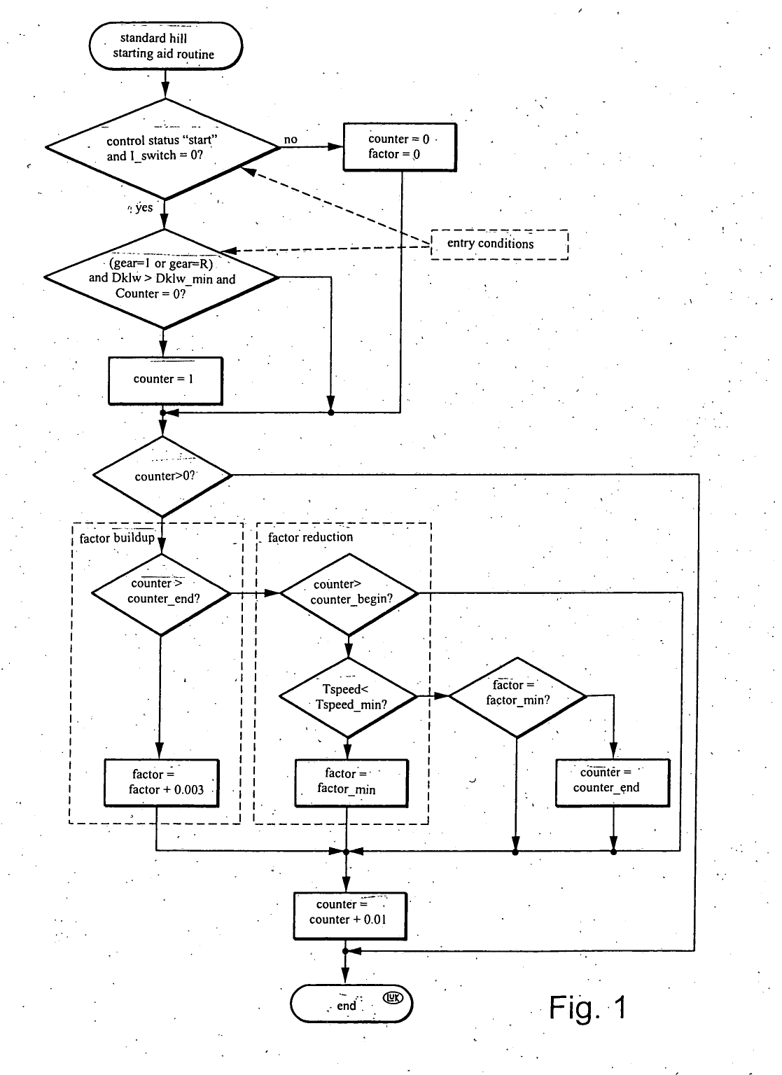

FIG. 1 shows a flow chart of a first exemplary embodiment of the starting aid routine, in which the following variables are used. The idle switch (I_switch), the throttle-valve angle (Dklw), the counter as the internal routine time, a factor, which is multiplied by the calculated clutch torque, and a transmission input speed (Tspeed).

In this exemplary embodiment, the minimum throttle-valve angle (Dklw_min), which is necessary for the entry of the routine and assumes the value 75°, for example, is used as a constant. Furthermore, the initial counter (Counter begin) is provided as a constant. This indicates at what time the motor speed increase is to begin. For example, this value may be 2000 (2 seconds). The counter at the end of the routine (Counter_end) is used as a further constant. This value indicates from when the clutch torque is built up again. This value may be 3000 (3 seconds), for example. A further constant is the minimum factor (Factor_min), which assumes the standard value 1. Using this constant, a desired clutch torque may be produced. Finally, a minimum transmission input speed (Tspeed_min), which is necessary in order to avoid a factor reduction, is also used as a constant.

The starting aid routine begins with checking the control status of the vehicle, whether a starting situation exists and whether the idle switch (I_switch) is equal to zero. It is then queried whether the first gear or the reverse gear is engaged and whether the throttle-valve angle (Dklw) is greater than a minimum throttle-valve angle and whether the counter is equal to zero. These are referred to as entry conditions.

If the counter is equal to 1 and/or greater than 0, the factor buildup is started, which is indicated in FIG. 1 by a dashed box. During the factor buildup, it is first checked whether the counter is greater than Counter_end, Counter_end indicating the time at which the clutch torque is to be built up again. This value may be 3 seconds, for example.

A second section of the present starting aid routine is provided as a factor reduction, which is also indicated by a dashed box in FIG. 1. During the factor reduction, it is first checked whether the counter is greater than Counter_begin. It may then be checked during the factor reduction whether the transmission input speed is less than a minimum transmission input speed, this minimum transmission input speed being necessary in order to suppress a factor reduction upon reaching this minimum transmission input speed. It is subsequently checked whether the factor is equal to a minimum factor, the minimum factor having a standard value of 1, the minimum factor being the factor value to be able to reduce the desired clutch torque. Finally, it is checked which value the counter has assumed. If the counter is equal to Counter_end, this means that the clutch torque may be built up again. In addition, the counter may then be increased to assume a value of counter +10 (0.01 seconds).

Finally, the routine is then ended. The above-mentioned routine may, for example, be called every 10 ms by the main controller or by the electronic clutch management (ECM). Of course, other suitable time intervals for calling the starting aid routine are also conceivable.

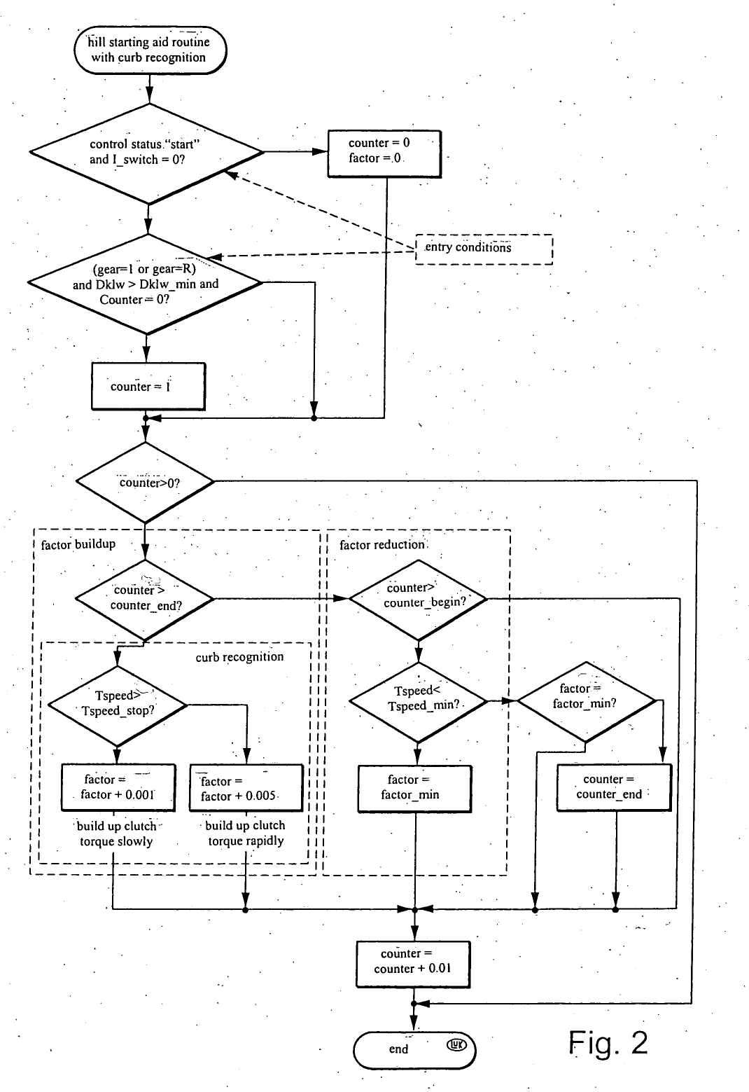

In FIG. 2, a second exemplary embodiment of the starting aid routine is explained, in which the following variables are used. The idle switch (I_switch), the throttle-valve angle (Dklw), the counter as the internal routine time, a factor, which is multiplied by the calculated clutch torque, and a transmission input speed (Tspeed).

In this exemplary embodiment, the minimum throttle-valve angle (Dklw_min), which is necessary for the entry of the routine and assumes the value 75°, for example, is used as a constant. Furthermore, the initial counter (Counter_begin) is provided as a constant. This indicates at what time the motor speed increase is to begin. For example, this value may be 2000 (2 seconds). The counter at the end of the routine (Counter_end) is used as a further constant. This value indicates from when the clutch torque is built up again. This value may be 3000 (3 seconds), for example. A further constant is the minimum factor (Factor_min), which assumes the standard value 1. Using this constant, a desired clutch torque may be produced. Furthermore, a minimum transmission input speed (Tspeed_min) is also used as a constant, which is necessary in order to avoid a factor reduction. Finally, a transmission input speed limit (Tspeed stop) is also used as a constant, which indicates whether the vehicle is standing or rolling.

In this starting aid routine, as in the first exemplary embodiment, the entry conditions are checked first. Unlike the starting aid routine shown in FIG. 1, in the second exemplary embodiment, a curb recognition is integrated within the factor buildup.

The curb recognition first checks whether the transmission input speed is greater than a predetermined transmission input speed limit in order to recognize whether the vehicle is moving.

As a function of this condition, the factor may assume a value +0.001. This means that the clutch torque is accordingly built up slowly. It is also possible for the factor to assume a value of +0.005 as a function of the above-mentioned condition. This means that the clutch torque is built up relatively rapidly. This starting aid routine may also be called every 10 ms, for example, by the main controller or the electronic clutch management.

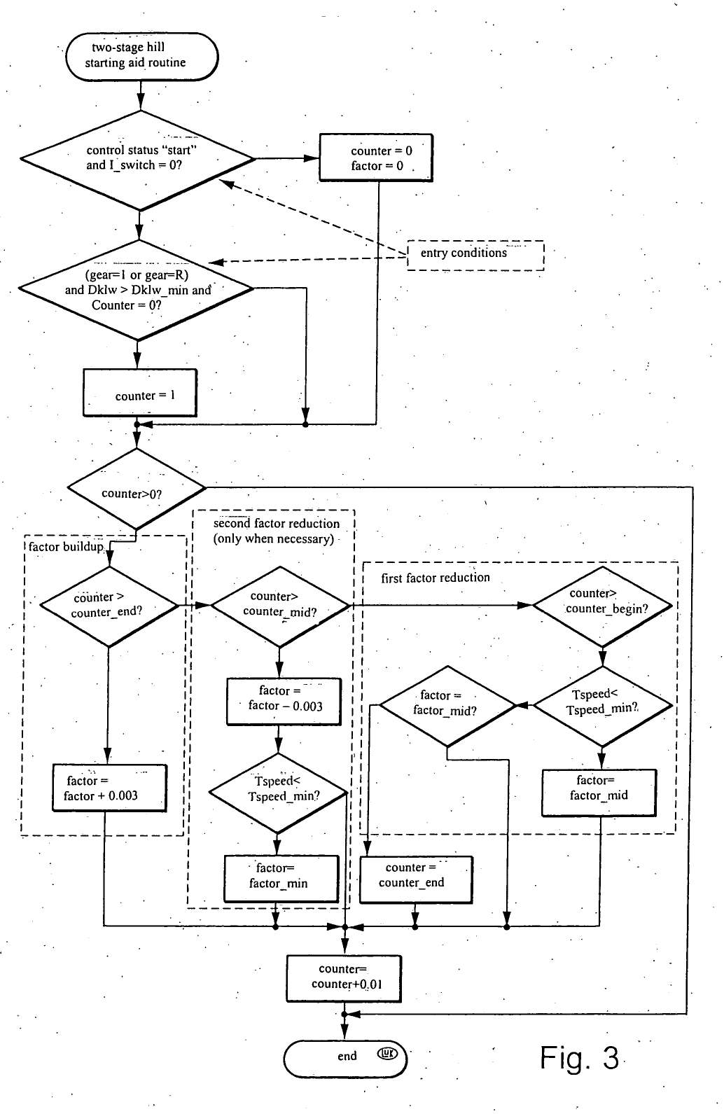

A third exemplary embodiment of the starting aid routine is explained in FIG. 3. In this embodiment of the starting aid routine, the idle switch (I_switch), the throttle-valve angle (Dklw), the counter as the internal routine time, the factor, which multiplies the calculated clutch torque, and the transmission input speed (Tspeed) are used as variables.

In addition, the minimum throttle-valve angle (Dklw_min), which determines the start of the routine and assumes the value 75°, for example, is used as a constant. Furthermore, the initial counter (Counter_begin) is provided as a constant. This indicates at what time the motor speed increase is to begin. For example, this value may be 2000 (2 seconds). A middle counter (Counter_mid) is also used as a constant, which indicates the time from when the clutch torque is built up again or possibly from when the second engine speed increase may begin. This value may be 3000 (3 seconds), for example. A further constant is the counter at the end of the routine (Counter_end). This value indicates from when the clutch torque is built up again and may assume a value of 4000 (4 seconds), for example. A further constant is the minimum factor (Factor_min). This factor has a standard value of 1, as the minimum factor is the value at which a second stage of the starting aid routine may generate the desired clutch torque.

In addition, a middle factor (Factor_mid) is used as a further constant, which has the standard value of 1. Upon reaching this value, in a first stage of the starting aid routine, a desired clutch torque is generated. Finally, a minimum transmission input speed (Tspeed_min) is also used as a constant, which is necessary in order to block the factor reduction.

This routine illustrated in FIG. 3 differs from the other exemplary embodiments by an additional second stage, which is referred to here as a second factor reduction. This starting aid routine may also be called every 10 ms by the main controller.

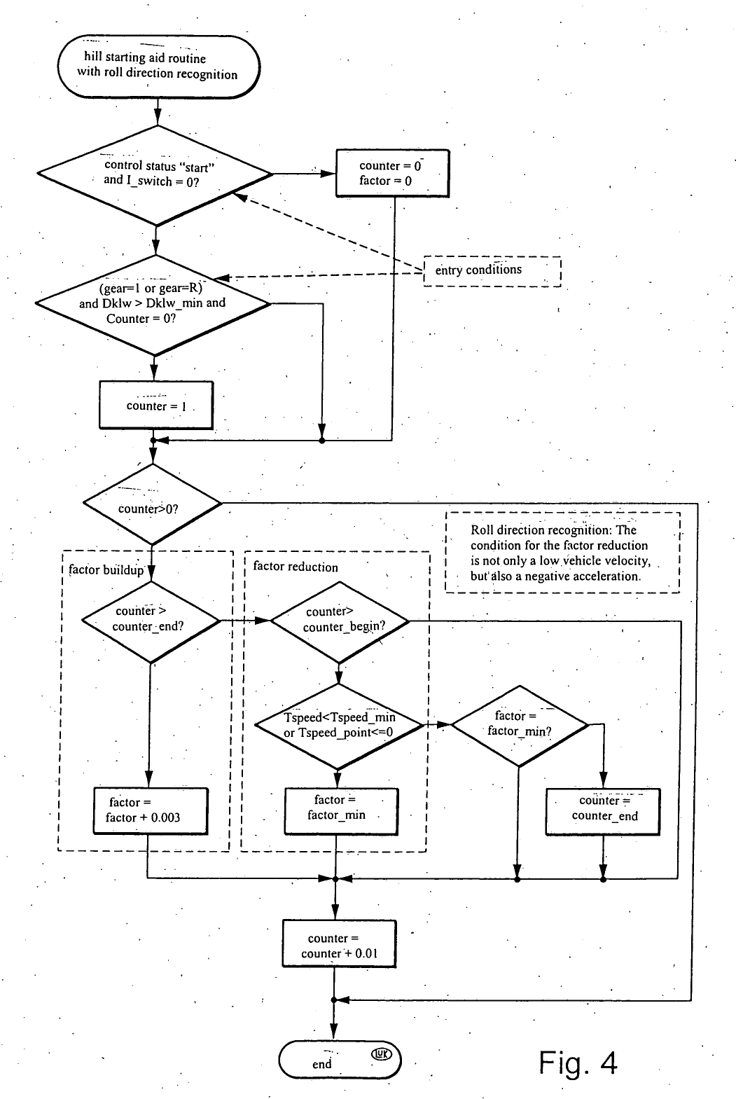

In FIG. 4, a fourth exemplary embodiment of the starting aid routine is explained, in which the idle switch (I_switch), the throttle-valve angle (Dklw), the counter as the internal routine time, a factor, which is multiplied by the calculated clutch torque, a transmission input speed (Tspeed), and a transmission input acceleration (Tspeed_point) are used as variables.

In this exemplary embodiment, the minimum throttle-valve angle (Dklw_min), which determines the entry of the routine and assumes the value 75°, for example, is used as a constant. Furthermore, the initial counter (Counter_begin) is provided as a constant. This indicates at what time the motor speed increase is to begin. For example, this value may be 2000 (2 seconds). The counter at the end of the routine (Counter_end) is used as a further constant. This value indicates from when the clutch torque is built up again. This value may be 3000 (3 seconds), for example. A further constant is the minimum factor (Factor_min), which assumes the standard value 1. Using this constant, a desired clutch torque may be generated. Finally, a minimum transmission input speed (Tspeed min) is also used as a constant, which is necessary in order to avoid a factor reduction.

This starting aid routine shown in FIG. 4 differs essentially through a roll direction recognition. In this roll direction recognition, it is checked whether the transmission input speed is less than a minimum transmission input speed or whether the transmission input speed acceleration is less than or equal to zero. The condition for the factor reduction may be, for example, the existence of a low vehicle velocity and/or a negative acceleration. This starting aid routine may also be called every 10 ms, for example.

What is claimed is:

1. A method for controlling and/or regulating a torque transmission system in a drivetrain, a clutch torque being changed as a function of a starting resistance of the vehicle in order to implement a strategy for starting the vehicle, the method comprising the step of:
modifying the strategy so that a progression of the clutch torque is adjusted to a starting situation.

2. The method as recited in claim 1 wherein the strategy influences the progression of the clutch torque as a function of the engine speed.

3. The method as recited in claim 1 wherein, for the starting situation of the vehicle on a hill, the clutch torque is built up slowly.

4. The method as recited in claim 1 wherein, for the starting situation of the vehicle over a curb, the clutch torque is built up rapidly.

5. The method as recited in claim 1 further comprising determining a velocity of the vehicle for use in the strategy.

6. The method as recited in claim 1 further comprising running a starting aid routine integrated in the strategy.

7. The method as recited in claim 6 further comprising running a multistage starting aid routine in the strategy.

8. The method as recited in claim 6 wherein a first stage and a second stage are provided in the starting aid routine.

9. The method as recited in claim 8 wherein a higher maximum speed is implemented in the second stage of the starting aid routine than in the first stage.

10. The method as recited in claim 6 wherein roll direction recognition of the vehicle is implemented in the starting aid routine.

11. The method as recited in claim 10 wherein the roll direction is recognized in any driving situation of the vehicle with the aid of at least one sensor.

12. The method as recited in claim 10 wherein, for the roll direction recognition, a gradient of a transmission input speed is observed at least during a predetermined time interval, a negative gradient of the transmission input speed indicating that the vehicle is rolling backward, and a positive gradient of the transmission input speed indicating that the vehicle is rolling forward.

13. The method as recited in claim 6 wherein engine speed regulation is provided in the starting aid routine.

14. The method as recited in claim 13 wherein, in the engine speed regulation, the clutch torque is reduced before the engine speed reaches a preset target engine speed.

15. The method as recited in claim 13 wherein, in the engine speed regulation, a target engine speed is determined by a constant component in combination with a second component, the second component being a function of the engine speed gradient.

16. The method as recited in claim 15 wherein the constant component in the engine speed regulation is implemented by a speed offset.

17. The method as recited in claim 1 further comprising determining if the vehicle is starting on a hill, and if so, building up the clutch torque at a predetermined rate.

18. The method as recited in claim 17 further comprising determining if the vehicle is against a curb, and if so, building up the clutch torque at a rate faster than the predetermined rate.

19. The method as recited in claim 1 wherein the vehicle is a motor vehicle.

20. A method for controlling and/or regulating a torque transmission system in a drivetrain, a clutch torque being changed as a function of a starting resistance of the vehicle in order to implement a strategy for starting the vehicle, the method comprising the steps of:
determining if a starting resistance of the vehicle is above a certain level, and
if so, modifying the strategy so that a progression of the clutch torque is adjusted by modifying a factor altering the clutch torque, the factor being modified by setting the factor to a first amount during a first time period so as to reduce the clutch torque, and increasing the factor by a predetermined rate after the first time period.
